(19) United States
(12) Patent Application Publication
(10) Pub. No.: US 2006/0047995 A1
(43) Pub. Date: Mar. 2, 2006

(54) Method and apparatus for diagnosing monitoring systems of technical equipment

(76) Inventor: Uwe Schriek, Berlin (DE)

Correspondence Address: BRINKS HOFER GILSON & LIONE, P.O. BOX 10395, CHICAGO, IL, 60610, US

(21) Appl. No.: 11/213,373

(22) Filed: Aug. 26, 2005

(30) Foreign Application Priority Data
Aug. 30, 2004 (DE) 10 2004 041 898.5

(51) Int. Cl. G06F 11/00

(52) U.S. Cl. 714/2

(57) ABSTRACT

A method is provided for diagnosing a monitoring system of technical equipment, the technical equipment having at least one unit, the at least one unit having a plurality of components of an identical or similar type. The method detects an error report for a defective component, associates a time stamp with the detected error report and/or with the defective component, and associates a location stamp with the detected error report and/or with the defective component. The method further performs an error diagnosis by checking whether the detected error report or a similar error report is logged for at least one other component having a location stamp identical or similar to the associated location stamp and/or having a time stamp identical or similar to the associated time stamp.

### FIELD

The present embodiments relate, in general, to monitoring systems, and in particular, to a method and an apparatus for diagnosing monitoring systems of technical equipment.

### BACKGROUND

In complex technical equipment which can comprise multiple components and be positioned at various locations, monitoring systems are utilized to provide a substantially error-free functioning of the technical equipment.

The terminology “technical equipment” can be used when relating to a power plant, such as a high-voltage plant, which comprises a plurality of potentially different components (switching units, transformers, lines, etc . . . ).

In monitoring, maintaining and/or servicing a system of a medical-clinical field, which has a plurality of components, such as imaging equipment (X-ray, CT, ultrasound, etc.), PCs, printers, lines for data transmission, and so forth, the provided method can also be implemented for error diagnosis of individual components.

Other fields of implementation of the provided method can be various complex technical equipments whose components may need an analysis, such as an error diagnosis or a search, to be performed. The individual components may be spatially distant from one another or may belong to different classes of devices.

In the event of an error, the error diagnosis may need to be performed in a substantially fast and responsive manner, so that a source of the error can be mitigated or removed in a relatively minimal time.

In prior servicing and/or maintenance systems, information that is linked with a concretely or provably defective device or component (and with a potential source of error) is saved, carried along and processed by the system.

However, this information may relate to only selected component data, such as a previous occurrence of defects in the applicable component in the past, the type of component, sources of error that typically previously occurred for that component, and so forth.

Typically, a servicing technician proceeds to search in a known monitoring system, for instance of a power distribution plant, for the defective component X, by consulting a data bank, or database or data store, that may contain collective error reports and associated diagnoses for a class of components of type X. The diagnoses contained in the data bank are analyzed for validity for the component X for the current error report.

### BRIEF SUMMARY

However, in the prior art procedures or methods, the service technician has no recourse or way of collecting selected environment information. As different or various types of components in the immediate surroundings might also have malfunctioned, and all the components, including the component to be diagnosed, are interfered with only by external, regionally dictated or imposed factors, such as aeronautical radio, cannot be detected by the known methods.

One aspect is to provide a method for improving a quality of an error diagnosis and/or search, and/or for associating instances of defects in various components in a piece or unit of equipment at various locations.

The provided method for diagnosing, such as error diagnosing, a monitoring system of technical equipment that includes a plurality of components, includes the following steps:
detecting an error report of a defective component of the technical equipment;
associating a time stamp with the detected error report and/or with the defective component; and/or
associating a location stamp with the detected error report and/or with the defective component; and
checking whether the error diagnosis is applicable to at least one other component having the associated location stamp and/or time stamp.

In one aspect, in an error search for a component recognized as defective, not only selected device sources of error are searched for and analyzed, but also sources of error that are independent of the defective component. These sources of error may be errors that are due to the spatial position of the defective component in the equipment, or errors that are due to a chronological occurrence of external factors, such as a typical development of an outside temperature in the course of a day.

A degree of agreement required between the location and/or time stamps to be compared may be adjustable. In another aspect, the error reports, with associated sources of error, which have either exactly the same (or identical) stamp or a similar stamp, are analyzed. A degree of similarity can in turn be determined or configured depending on the type or size of the equipment. If, still additional stamps are assigned, for example for selected parameters of the device, then the degree of agreement between these stamps can also be adjusted.

In still another aspect, the provided method is implemented using a two-layer process. A first layer relates to the error based diagnosis, as in known error diagnosis systems; a second layer relates to information on a meta-level. Information about the error diagnosis is used again here for error diagnosis. This meta-level information, however, is not related only to the defective component or to the similar type of components but instead relates to still other components of different types in the technical equipment that may meet predetermined or selected preconditions. The two layers can be executed in parallel and/or sequentially. As such, the two-layer diagnosing method provides an improved topology in metrics in a display space for device defects that takes the location and/or time of the occurrence of defects into account.

Devices, which are composed of different types located in proximity of defective components, are also put in relation to one another with respect to the error diagnosis.

For each error report and/or for each defective component, a location position may be detected. This location position is used as meta-information. If a defect in a component is being examined, then a check is performed as to whether the error source is identical as in another component with the same or similar location position. Thus, a regional accumulation of certain defects in potentially different components can be taken into account and used for diagnosis.

However, the location position may not be the only meta-information used for the diagnosis. Furthermore, in addition or alternately, the monitoring system detects a chronological occurrence of an error and/or an error report. Each error and/or error report is given a time stamp. The time stamp can further be used as meta-information. If a defect in a component is being examined, then a check is performed as to whether the same error source caused a defect in another component with the same or a similar time stamp, such as the same time of day or the same day of the week. Thus, a chronological accumulation of certain errors of potentially different components can be taken into account and used for diagnosis.

Depending on the type of equipment to be monitored, the degree of agreement in terms of the meta-information can be preset, such as with regard to the location position or the location stamp and/or with regard to the time stamp. Thus, selected conditions of the technical equipment can be taken into account. In a high-voltage plant, for example, a circle or group of components with a similar location stamp should be drawn markedly larger than for a computer network made up of a PC, printer, and screen.

In still another aspect, all the error diagnoses of all components are detected and stored in memory. Alternately, however, a selection can be made such that only relevant error reports are stored in memory, which can also be used as appropriate information for subsequent error reports or diagnoses.

Typically, the meta-information relates to error reports already diagnosed. Thus, the error diagnoses are performed by checking whether an already-diagnosed defect of another component that has been reported has the same or a similar time and/or location stamp. If so, the already-performed diagnosis can be adapted for the current case.

In large, complex technical equipment, a relatively large number of error reports per unit of time can occur, so that an error report may be unsolved or not yet diagnosed while still other error reports are already logged or provided. As such, the related error reports of other components have not yet been diagnosed, either. For the error diagnosis, however, a criteria that relates to all components may be searched. This criteria search may minimize the search for the error and can speed up the corresponding diagnosis.

In another aspect, the proposed method may include in the error diagnosis components of the equipment of different types, designs, and/or functions. In a high-voltage switching unit, components that relate to supplying and/or drawing off energy can be set into relation with circuit components and/or transformers, even though these components have a substantially different device profile and are different in type and function. In data banks used in the prior art, component-independent error reports and associated diagnoses were not put into correlation with each other. Yet if these defective components are located near one another, then errors that are due, for example, to transient over-voltages which in turn can be caused by electromagnetic interfering radiation that is propagated through the conductors, can be diagnosed substantially quickly and relatively simply.

Still other meta-information can be used besides the location stamp and the time stamp. As such, all significant parameters or selected parameters, of the applicable component are detectable. This parameter detection is performed for all components in the equipment. The error diagnosis is then performed by checking whether the same or similar error diagnosis is applicable to a defect of another component with the same or a similar selected parameter. This diagnostic method covers diagnoses that may be based on the fact that in the same or similar devices, similar defects may occur.

In still another aspect, the various classes of meta-information may be set in correlation with one another. The error diagnosis is thus performed by putting the time stamp, the location stamp, and optionally other significant or selected parameters of the component or components in relation with one another.

Depending on the size of the technical equipment, a component or components examined that have the same or a similar location stamp and a component or components that have the same or a similar time stamp match may be identical or may correspond to different units of the technical equipment.

The provided method utilizes a data bank system and/or an expert system. The generated diagnoses are stored in memory of these systems.

Typically, the defect of the other component or components is one that has already been diagnosed. As such, a check is performed as to whether the source of error that relates to this other component might also relate to the component to be diagnosed. However, the defect of the other component may still be an undiagnosed defect. Then, whether the other defect and the defect to be diagnosed may have a similar or corresponding source of error is checked.

In another aspect, the provided diagnostic method may offers a flexibility that for the error diagnosis, an arbitrary number of components that meet predetermined conditions, such as having the same or similar time stamp and/or location stamp, can be analyzed. Thus, all the components or selected components that have a similar location stamp and all the components or selected components that have a similar time stamp can be examined. A maximum number of components to be analyzed can be adjusted so as to vary duration of the diagnosis.

For the above-described aspects, the diagnostic method can also be provided as a computer program product, with a medium that is readable by a computer and with a computer program and associated program code. Once the computer program is loaded, the computer is instructed to perform the above-described method.

Alternately, a storage medium is provided to store the above-described computer-implemented method in memory, which is readable by a computer.

The present embodiments are defined by the appended claims. This summary describes some aspects of the present embodiments and should not be used to limit the claims. In the following detailed description of the drawings, illustrative and exemplary embodiments that are not to be understood as limiting are described and discussed along with their characteristics in further detail below with reference to, and in conjunction with the drawings.

### BRIEF DESCRIPTION OF THE DRAWINGS

FIG. 1 is a flow chart illustrating a method for diagnosing a monitoring system; and

FIG. 2 is a schematic block diagram illustrating an apparatus for diagnosing a monitoring system.

### DETAILED DESCRIPTION OF THE DRAWINGS AND THE PRESENTLY PREFERRED EMBODIMENTS

The detailed drawings described below relate predominantly to the implementation of the proposed method and apparatus to the field of power supply plants, as an example. However, any other kinds of distributed, multi-component technical equipment may be the basis for implementing the proposed method and apparatus.

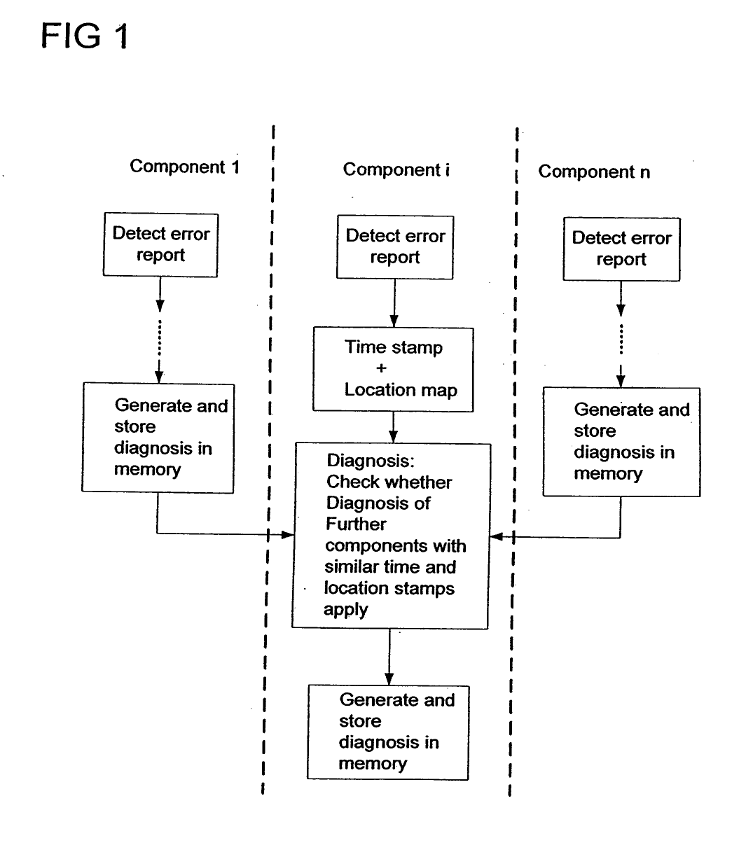

Referring to FIG. 1, a relatively elaborate or complex unit of technical equipment 10 comprises a plurality of different components K1, K2, K3, . . . , Ki, where i is from 1 to j. The components Ki are devices or device modules of the equipment 10, a subset of these components Ki may belong to the same or different classes of device. The components Ki may be switching units, transformers, or line modules and may thus have different selected device parameters.

If a component Ki proves to be defective, a report is communicated to the monitoring system, and the associated report is detected as an error report. For this error report, a time stamp and a location stamp are assigned; the stamps define the time the error occurred and the position of the component Ki, respectively. This procedure or method is performed for components Ki of the equipment 10 and/or for error diagnoses of the equipment 10.

The time stamp and the location stamp are meta-information which the proposed method uses for automatically generating a diagnosis.

If a diagnosis is to be performed for a component Ki, then a check is performed as to whether diagnoses for other components Kn with a similar time and/or location stamp were also performed. These other components Kn do not need to belong to the same or similar device class. In the affirmative, the error reports and the associated diagnoses are analyzed as to whether they can also relate to the error report and diagnosis of component Ki. In the affirmative, the diagnosis can be adopted 1:1 to the Ki diagnosis (from component Kn to component Ki). If not, recourse is made to alternate mechanisms for diagnosis of component Ki.

The diagnosis may be automatically generated and stored in memory in the monitoring system, so as to be available for future error diagnoses for other components Kn.

Depending on the size and type of the equipment 10, the other components Kn analyzed for diagnosis may differ in their number. In a closely interlinked unit of equipment 10, a plurality of other components Kn may be identified to have the same or a similar location stamp. If the equipment 10 comprises a substantially large number of components Ki that are also active at the same time, then a plurality of other components Kn may also be identified to have the same or a similar time stamp, or in other words have become defective at nearly the same time. The other components Kn identified (with matching time and/or location stamps and/or other matching parameters) are used for the automatic diagnosis.

The proposed method relates to a diagnosis of errors or of defective components K. However, the proposed method can equally be implemented to the diagnosis of or search for predetermined events. For example, a cause of an event (such as a repeated report) in a component Ki in a unit of equipment 10 may need to be identified. This event need not be an error.

Typically, the time stamp is allocated or associated to the error report detected, since the error report occurs virtually simultaneously with the occurrence of the error. However, the time stamp may first be allocated to the error report, since at that time, the error is not yet determined. Then, the time stamp is assigned to the error.

For the proposed method, the location stamp is assigned to the defective component Ki. However, if the component Kj that detects the error and the defective component Ki differ, and if at an initial time the defective component Ki is properly located, then the location stamp can also be assigned to the error report in a first step and to the defective component Ki in a later, second step.

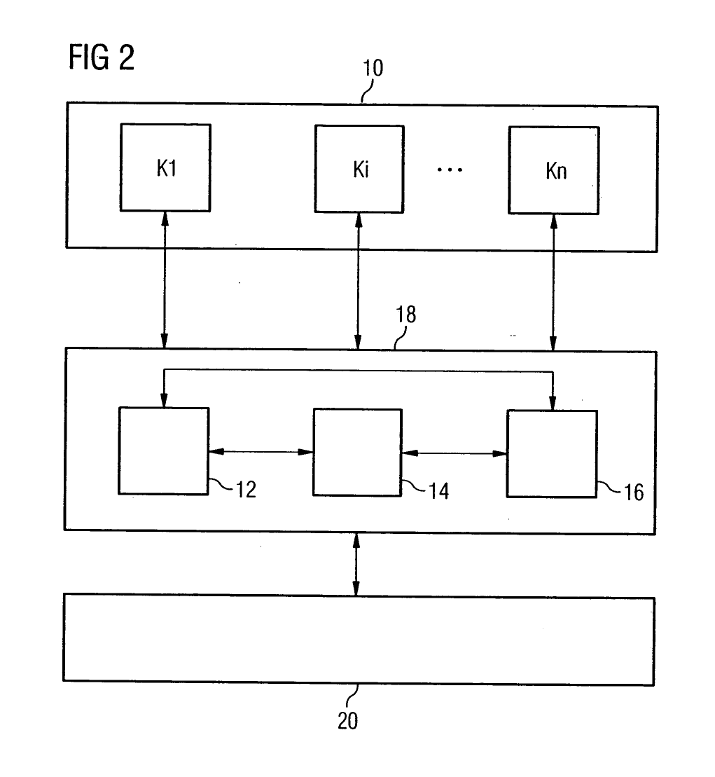

Now referring to FIG. 2, an apparatus 18 includes a detection module 12, an association module 14, and a diagnosis module 16. The modules 12, 14, 16 are in data exchange communication with one another. Each component Ki of the equipment 10 is connected for data exchange to the apparatus 18. The apparatus 18 can access a knowledge management system 20, which may be a data bank and/or an expert system. The access to the data bank system and/or expert system 20 is performed from the apparatus 18, not directly from the component Ki of the equipment 10. In the prior art, every component Ki, or the equipment 10 per se, was in direct contact with the data bank 20. Via the only indirect access, of the component Ki to the data bank 20, the meta-information and diagnoses maybe stored in memory, since the apparatus 18 provides for automatic memorizing of the diagnoses.

Moreover, the proposed method may assign both a location stamp and a time stamp and uses both of these stamps for the automatic diagnosis. Alternately, only the time stamp or only the location stamp may be used for the automatic diagnosis. This usage of the stamps can be configured by an administrator, depending on the type of equipment 10 to be checked.

Alternately, even not selected device parameters can be taken into account in the diagnosis.

If the location and/or the time stamp are used, then the error diagnosis can be speeded up. If the technical field of interest in which the proposed diagnostic method is implemented is, for example, technical maintenance of a power supply plant or of a health administration system, then errors that relate to malfunctions in the equipment 10 that are caused by aeronautical radio can be detected substantially quickly and relatively simply. Such arrangement was previously not available, since selected environment parameters were not be taken into account.

The monitoring system can implement a metric which incorporates one or more of the parameters of the meta-information as a basis for a similarity comparison.

It is therefore intended that the foregoing detailed description be regarded as illustrative rather than limiting, and that it be understood that it is the following claims, including all equivalents, that are intended to define the spirit and scope of this invention.

1. A method for performing a diagnosis in a monitoring system of technical equipment, the technical equipment having at least one unit, the at least one unit having a plurality of components of a same or similar type, the method comprising the following steps:
detecting an error report for a defective component;
associating a first time stamp with the detected error report and/or with a defect;
associating a first location stamp with the detected error report and/or with the defective component; and
checking whether the detected error report or a similar error report exists for at least one other component having a same or similar location stamp to the first location stamp, having a same or similar time stamp to the first time stamp, or combinations thereof.

2. The method of claim 1, further comprising:
detecting at least one parameter of the defective component; and
checking whether a first error diagnosis is applicable to a detected error report of another component having a same or similar selected parameter.

3. The method of claim 1, wherein the checking comprises correlating the first time stamp, the first location stamp, a selected parameter of the defective component or combinations thereof to each another.

4. The method of claim 1, wherein the detected error report or the similar error report is logged for two components, with one of the two components having the identical or similar location stamp and the other of the two components having the identical or similar time stamp, the two other components are of a same type or correspond to separate units of technical equipment.

5. The method of claim 1, wherein the monitoring system accesses a database or an expert system, and is integral to a maintenance or diagnosis system.

6. The method of claim 1, wherein an error of the at least one other component or components is a diagnosed error or an undiagnosed error and is caused by an identical error source.

7. The method of claim 1 implemented by the monitoring system for the at least one unit of technical equipment.

8. The method of claim 2, wherein the checking comprises correlating the first time stamp, the first location stamp, a selected parameter of the defective component or combinations thereof to each another.

9. The method of claim 9, wherein the detected error report or the similar error report is logged for two components, with one of the two components having the identical or similar location stamp and the other of the two components having the identical or similar time stamp, the two other components are of a same type or correspond to separate units of technical equipment.

10. The method of claim 10, wherein an error of the two components is a diagnosed error or an undiagnosed error and is caused by an identical error source.

11. An apparatus for diagnosis in a monitoring system of technical equipment, the technical equipment having a plurality of components, the apparatus comprising:
at least one detection module operable to detect an error of a defective component;
at least one association module operable to associate a first time stamp with the detected error, with the defective component or with both the detected error and the defective component, operable to associate a first location stamp with the detected error, with the defective component, or with both the detected error and the defective component, or operable to associate both the location and time stamps; and
at least one diagnosis module operable to check whether an error diagnosis is applicable to an error report of at least one other component having a same or similar location stamp to the first location stamp, having a same or similar time stamp to the first time stamp or having both a same or similar time and location stamps.

12. The apparatus of claim 12, wherein the plurality of components are of different types, constructions, functions or combinations thereof.

13. The apparatus of claim 12, further comprising:
an expanded detection module operable to detect at least one selected parameter of the defective component in conjunction with the detected error report, and the diagnosis module operable to check whether the error diagnosis is applicable to an error report of another component having a same or similar parameter to the selected parameter.

14. The apparatus of claim 12, wherein the error diagnosis is performed by correlating the time stamp, the location stamp, a selected parameter or combinations thereof of the error report or of the defective component to corresponding information in error reports stored in memory in the monitoring system.

15. The apparatus of claim 12, wherein the detected error report or a similar error report is logged for two components, with one of the two components having a same or similar location stamp as the first location stamp and the other of the two components having a same or similar time stamp as the first time stamp, the two components are of same type or correspond to separate units of technical equipment.

16. The apparatus of claim 12, wherein the apparatus accesses a knowledge management system, the management system comprises a data bank, an expert system or both a data bank and an expert system and is integral to a maintenance, diagnosis or both maintenance and diagnosis system.

17. The apparatus of claim 12, wherein the error of the at least one other component or components is a diagnosed error.

18. The apparatus of claim 12, wherein the error of the at least one other component or components is an undiagnosed error.
